(19) United States
(12) Patent Application Publication
(10) Pub. No.: US 2001/0033573 A1
(43) Pub. Date: Oct. 25, 2001

(54) Asynchronous transfer mode adaptation layer apparatus

(76) Inventor: Hyun-Soo Paik, Ichon-shi (KR)

Correspondence Address: BAKER & BOTTS, 30 ROCKEFELLER PLAZA, NEW YORK, NY, 10112

(21) Appl. No.: 09/841,629

(22) Filed: Apr. 24, 2001

(30) Foreign Application Priority Data
Apr. 25, 2000 (KR) 2000-21923

(51) Int. Cl. H04L 12/28

(52) U.S. Cl. 370/395; 370/374

(57) ABSTRACT

Disclosed is an ATM adaptation layer apparatus. The ATM adaptation layer apparatus according to the invention includes an ATM adaptation layer processor connected to an external Utopia level 2 matching device for processing and outputting a virtual path and a virtual channel of input/output cell data, an ATM routing processor having one end connected to the ATM adaptation layer processor and the other end connected to an external ATM switch for processing a routing path of the input cell data, and a controller for downloading program data from outside, generating corresponding control signals, and outputting data on a communicating status to outside. Under the conventional technology, data services are provided in a low speed in a narrow bandwidth, which is the worst drawback of the line exchanging method. Under the present invention, by contrast, the bandwidth is enhanced from a minimum 2M bps to a maximum 622M bps. Furthermore, dynamic image can be assisted in multimedia services recently provided through mobile phones. In addition, the present invention is highly available and applicable to any kinds of hardware if it is a system using ATM cell data.

### FIELD OF THE INVENTION

The present invention relates to an ATM adaptation layer processing apparatus, and in particular, to an asynchronous transfer mode adaptation layer apparatus, processes an ATM adaptation layer for exchange connection in accordance with a path of input/output cell data.

### DESCRIPTION OF THE PRIOR ART

In general, the layer structures used in an ATM method can be classified into three layers: an ATM physical layer; an ATM adaptation layer; and an upper layer. Also, in an ATM network, all the information is transmitted and received in a cell unit. Therefore, the parts related to transmission of cell data are not processed in accordance with transmission media such as voice, data or image, or services. However, the quality required for each service, e.g., a delaying time or a delaying rate, differs in each service. Therefore, it is necessary to incorporate the differences of quality conditions in making each of the original services as cell data. Such a function is performed on an ATM adaptation layer (AAL), and the apparatus performing such a function is referred to as an ATM adaptation layer apparatus.

However, the conventional ATM adaptation layer apparatus as described above is capable of assisting in voice services or data services only equivalent to 64K bps level that are installed in a mobile communication system of the second or second and a half generation. Hence, the conventional ATM adaptation layer apparatus has a drawback of being incompatible with an IMT 2000 system loaded on data communication of higher than 64K bps level.

Furthermore, in an ultra-speed data communication, an ATM adaptation layer apparatus is critical to comprise a virtual path matched with ATM cell data and a virtual circuit data as well as to exchange each ATM cell data in a high speed.

### SUMMARY OF THE INVENTION

It is, therefore, an object of the present invention to solve the above problems and satisfy the above needs by providing an asynchronous transfer mode adaptation layer apparatus, which is compatible with an IMT 2000 system assisting in the data communication of higher than 64K bps level.

To achieve the above object, there is provided an ATM adaptation layer apparatus, comprising: an ATM adaptation layer processor connected to an external Utopia level 2 matching apparatus for processing and outputting a virtual path and a virtual channel of input/output cell data; an ATM routing processor, one end of which is connected to the ATM adaptation layer processor and the end of which is connected to an external ATM switch for processing routing path of the input cell data; and a controller for downloading program data from outside and generating corresponding signals so as to output data on a communicating status to outside.

### BRIEF DESCRIPTION OF THE DRAWINGS

The above and other objects, features and advantages of the present invention will become more apparent from the following detailed description when taken in conjunction with the accompanying the drawings, in which:

FIG. 1 is a block diagram illustrating a construction of an asynchronous transfer mode adaptation layer apparatus according to the present invention; and

FIG. 2 is a block diagram illustrating an embodiment of the asynchronous transfer mode adaptation layer apparatus according to the present invention.

### DETAILED DESCRIPTION OF THE PREFERRED EMBODIMENT

A preferred embodiment of the present invention will be described herein below with reference to the accompanying drawings. In the following description, well-known functions or constructions are not described in detail since they would obscure the invention in unnecessary detail.

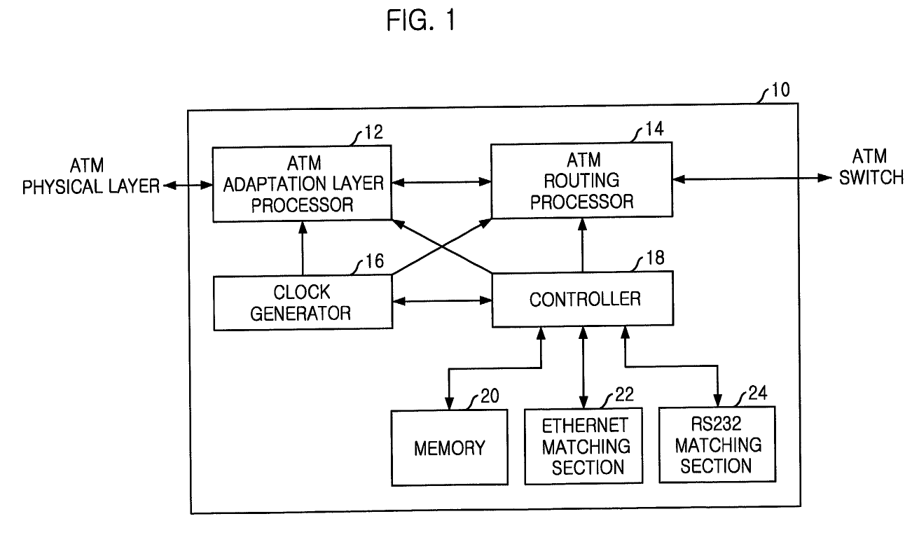

FIG. 1 is a block diagram illustrating a construction of an asynchronous transfer mode adaptation layer apparatus according to the present invention. Referring to FIG. 1, an ATM adaptation layer apparatus 10 mainly comprises an ATM adaptation layer processor 12 connected to an ATM physical layer, an ATM routing processor 14 connected to an ATM switch, and a controller 18 generating control signals in accordance with a program pre-stored inside thereof.

Also, a clock generator 16 for generating a predetermined clock is connected to the ATM adaptation layer processor 12. A memory 20, an Ethernet matching section 22 and an RS232 matching section 24 are connected to the controller 18.

An embodiment of the adaptation layer apparatus 10 constructed above will now be described in further detail.

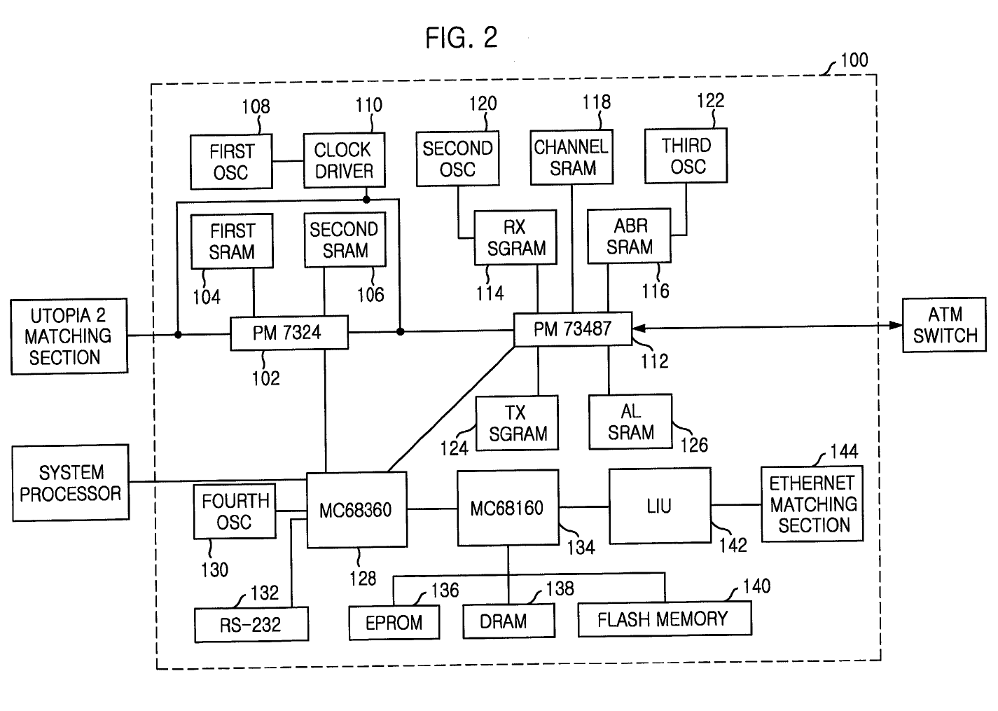

FIG. 2 is a block diagram illustrating an embodiment of the asynchronous transfer mode adaptation layer apparatus according to the present invention. Referring to FIG. 2, an ATM adaptation layer apparatus 100 comprises: a PM7324 102 connected to a Utopia level 2 matching section; a first and a second SRAM 104, 106 respectively connected to the PM7324 102; and a first clock generator 108 connected to both ends of the PM7324 for supplying a first clock through a clock driver 110.

The AMT adaptation layer apparatus 100 further comprises: a PM73487 112 connected between the PM7324 102 and the ATM switch; an RX SGRAM 114, ABR SRAM 116, and a channel SRAM 118, respectively connected to the PM73487 112; a second clock generator 120 connected to the RX SGRAM 114 for supplying the second clock; and a third clock generator 122 connected to the ABR SRAM 116 for supplying the third clock.

The ATM adaptation layer apparatus 100 further comprises a TX SGRAM 124 connected to the PM73487 112, and an AL SRAM 126 connected to the PM73487 112.

The ATM adaptation layer apparatus 100 further comprises: an MC68360 128 connected to a system processor; a third clock generator 130 for supplying the third clock to the MC68360 128; an RS232 132 for assisting in an RS-232 communication with outside; an MC68160 134 connected to the MC68360; and an EPROM 136, a DRAM 138, and a flash memory 140, respectively connected to the MC68160 134.

The ATM adaptation layer apparatus 100 further comprises an LIU 143 connected to the MC68160 134, and an Ethernet matching section 144 connected to the LIU 142 for performing an Ethernet matching.

The following is a detailed description of the constitutional elements and operational flow of the ATM adaptation layer apparatus constructed above.

When a power supply is initially turned on hardware of the MC68360 is set up by a booting program in the EPROM.

In order to initialize the ATM adaptation layer by initializing the system source through an access to a downloaded program, it is mandatory to initialize a VPI/VCI address table in the first SRAM and the second SRAM. This is realized through the PM7324 102. To be specific, the MC68360 128 writes the VPI/VCI address table in the first and the second SRAM through an access to the processor matching section of the PM7324 102.

If this process is completed, ATM routing processor also needs to initialize the RAM region. The MC68360 writes the VPI/VCI address value in the SGRAM region of the transfer/reception connection table through the CPU matching section of the PM73487 112. The address searching table also writes the VPI/VCI value to be transferred or received to an AL SRAM in the same manner. SRAM, which is used to assist in the ABR service, writes a location of the particular VPI/VCI values assisting in the ABR written in the SGRAM in the ABR SRAM 116.

Accordingly, the ATM cells inputted from the Utopia level 2 are inputted to the PM7324 102. The PM7324 102 searches the content of the first SRAM from the inputted cells. If the received ATM address is found among the inputted cells, the content of the second SRAM is searched. Then, the received ATM cell address is converted to another ATM cell address so as to be transferred to the ATM routing processor.

The PM73487 112, which is an ATM routing processor, receives cells transferred from the ATM adaptation layer, and first searches the address searching table of the AL SRAM. If the currently received cell address is found among the address searching table, the content of the received SGRAM is searched again. The address of the ATM cell is converted to a switch fabric so as to be transferred.

If the received cell is an address corresponding to the ABR, the ATM address is converted to a content of the ABR SRAM by reference to the ABR SRAM so as to be transferred to a switch fabric. The ATM cell received from the switch fabric, is received by the ATM routing processor. The ATM routing processor first searches the content of the AL SRAM. If the received cell is not found among the AL SRAM, the ATM routing processor disposes of the AL SRAM, and writes the received VPI/VCI value as well as the number of the received cells. If the received cell is found among the AL SRAM, the ATM routing processor picks up the content of the transferred SGRAM, and converts the received cell address to transfer the same to the ATM adaptation layer. The PM7324 102 searches the content of the second SRAM among the ATM cells received by the ATM routing processor, and converts the ATM cell address so as to transfer the same to the Utopia level 2.

The PM7324 102 performs a serial communication with the system processor to notify the system processor of the alarm state, number of transferred and received ATM cells, and the number of ATM cells not to be received, etc.

A preferred embodiment of the present invention constructed above has the following advantages.

First, under the conventional technology, data services are provided in a low speed in a narrow bandwidth, which is the worst drawback of the line exchanging method. Under the present invention, by contrast, the bandwidth is enhanced from a minimum 2M bps to a maximum 622M bps. Furthermore, dynamic image can be assisted in multimedia services recently provided through mobile phones.

In addition, the present invention is highly available and applicable to any kinds of hardware if it is a system using ATM cell data.

Although the preferred embodiments of the invention have been disclosed for illustrative purpose, those skilled in the art will be appreciate that various modifications, additions and substitutions are possible, without departing from the scope and spirit of the invention as disclosed in the accompanying claims.

What is claimed is:

1. An ATM adaptation layer apparatus, comprising:
an ATM adaptation layer processor connected to an external Utopia level 2 matching device for processing and outputting a virtual path and a virtual channel of input/output cell data;
an ATM routing processor having one end connected to the ATM adaptation layer processor and the other end connected to an external ATM switch for processing a routing path of the input cell data; and
a controller for downloading program data from outside, generating corresponding control signals, and outputting data on a communicating status to outside.

2. The ATM adaptation layer apparatus of claim 1, wherein the ATM adaptation layer processor comprises:
a first SRAM, on which a virtual channel and a virtual path address of the cell data inputted from the external Utopia level 2 matching section are loaded; and
a second SRAM, on which a virtual channel and a virtual path address of the cell data outputted to the external ATM switch are loaded.

3. The ATM adaptation layer apparatus of claim 1, wherein the ATM adaptation layer processor further comprises a first clock generator provided at one end thereof for generating a first clock, and a clock driver provided at the other end thereof for transferring the first clock signal of the first clock generator to the ATM adaptation layer processor.
